(19) United States
(12) Patent Application Publication
(10) Pub. No.: US 2025/0121966 A1
(43) Pub. Date: Apr. 17, 2025

(54) Mobile Structure for Dispatching and Accommodating Drones

(71) Applicant: HHLA Sky GmbH, Hamburg (DE)

(72) Inventors: Matthias GRONSTEDT, Hamburg (DE); Olaf HILBIG, Kirchlengern (DE); Stefan OLUSCHINSKY, Kirchlengern (DE); Marius SCHRODER, Bielefeld (DE)

(73) Assignee: HHLA Sky GmbH, Hamburg (DE)

(21) Appl. No.: 18/692,644

(22) PCT Filed: Sep. 15, 2022
(86) PCT No.: PCT/EP2022/075712

§ 371 Date: Oct. 9, 2024

(30) Foreign Application Priority Data
Sep. 16, 2021 (DE) 10 2021 123 992.3

(51) Int. Cl. B64U 70/99; B64F 1/32; B64U 70/50; B64U 80/10; B64U 80/25; B64U 80/40; B64U 101/64

(52) U.S. Cl. CPC B64U 70/99; B64F 1/32; B64U 70/50; B64U 80/10; B64U 80/25; B64U 80/40; B64U 2101/64

(57) ABSTRACT

The invention relates to a mobile structure for dispatching and accommodating drones, comprising a landing platform, a lifting unit for adjusting the height of the landing platform, and a storage unit. The lifting unit allows lifting and lowering of the landing platform up to a height from which a drone can take off and land (take-off height), and to a height in which the landing platform can transfer a drone to a storage level of the storage unit or receive the drone from a storage level (storage level height).

The subject-matter of the invention is a mobile device for dispatching and receiving drones.

Mobile devices for dispatching and receiving drones have already been proposed. WO 2019/197606 A1 proposes a sea freight container that has a charging unit for charging a drone with electrical energy, as well as a communication unit for communicating with the drone, the sea freight container being realized as a launching and landing platform for the drone, the sea freight container having a roof that is designed to open and close in order to store the drone inside the sea freight container and to let it out of the sea freight container for a surveillance flight.

The object of the invention is to provide a mobile device for dispatching and receiving drones that has advantages in comparison with known devices.

The object is achieved by a device according to claim 1. Further advantageous embodiments are provided by the dependent claims or described below.

The lifting unit for adjusting the height of the landing platform allows the landing platform to be moved to a height that is advantageous for launching and/or landing the drone, and may also be moved to a height that is advantageous for transferring the drone from the landing platform into the storage unit and vice versa. By accommodating the various units in a common unit, the device according to the invention forms a “drone hangar”.

Preferably, the landing platform, the lifting unit and the storage unit are fastened in a transport frame. Preferably, the transport frame can be inserted as a complete module into a container, preferably a standard sea freight container. This has the advantage that the mounting of the individual components may be effected first without the outer casing of a container. The individual components are thus easily accessible for mounting. In particular, a control cabinet may also be fastened to the transport frame.

Preferably, the sea freight container has a roof that is designed to open and close. This opening and closing is preferably controlled by the drone itself.

Preferably, the storage unit comprises a rotary unit that can rotate about a vertical axis and has two storage levels arranged on opposite sides of the vertical axis. Preferably, the two storage levels are arranged vertically offset from each other, such that, as viewed from above, the drone stored on one storage level can overlap the drone stored on the other storage level without the drones touching each other. Preferably, the storage unit comprises two rotary units arranged one above the other. Preferably, a storage level comprises a conveying system, comprising a conveying track or a roller track, that enables a drone to be received and/or transferred to the landing platform. Preferably, the conveying system has a lateral delimitation.

Preferably, the contact surface of the drone in the storage position is constituted by the conveying or roller track.

Preferably, the rotary unit can be positioned in steps of 90-degrees. Preferably, the position of the rotary unit is sensed by means of sensors. Preferably, the storage levels have hold-down devices for holding down skids of a landing frame of a drone. Preferably, the storage position of the drone is sensed by means of sensors. Preferably, the conveying system has drivers for transferring the drone to the parking level. Preferably, the drone is pulled onto the storage level by the conveying system and moved toward end stops. Preferably, the storage position is recognized by means of sensors. Preferably, a locking mechanism can fix the drone in place on the storage level.

Preferably, the lifting unit enables the landing platform to be raised and lowered to a height from which a drone can launch and land (launching height), and to a height at which the landing platform can transfer a drone to a storage level or receive it from a storage level (storage-levels height).

Preferably, the rotary unit can also be rotated when a storage level is at the same height as the landing platform. Preferably, a battery of a drone stored on the storage level can be charged in a position of the storage level. Preferably, charging is effected by means of a charging lance. Preferably, following a 180 degree rotation from the transfer position of the storage level, the storage level is accessible to a person.

Preferably, the landing platform comprises a landing surface comprising two drone conveyor belts that are arranged in parallel in the same horizontal plane and that are spaced apart such that a drone standing on the landing surface can have contact with both drone conveyor belts simultaneously, two sliding bars, which each extend at least partially parallel to the running direction of the drone conveyor belts and can be moved toward each other above the drone conveyor belts in a direction perpendicular to the running direction of the drone conveyor belts, such that they can displace a drone standing on the landing surface, wherein the drone standing on the landing surface can be moved, by movement of the drone conveyor belts and/or movement of the sliding bars, into a position in which the drone can be transferred to a storage level (drone transfer position).

Preferably, a drone can be moved, by movement of the drone conveyor belts and/or movement of the sliding bars, into a horizontal position in which the drone can launch (horizontal launching position of the drone).

Preferably, the landing platform comprises a cargo loading unit comprising a hoist for cargo, between the drone conveyor belts, a cargo conveyor belt for moving the cargo onto the hoist, wherein the drone standing on the landing surface can be moved, by movement of the drone conveyor belts and/or movement of the sliding bars, into a position in which the drone can receive cargo arranged on the hoist (loading position).

Preferably, the drone conveyor belts are realized as modular conveyor belts. Preferably, the individual elements of the modular conveyor belts are at least partially open, such that moisture can drain off.

Preferably, the landing surface, the sliding bars and the cargo loading unit are attached to a framework.

Preferably, the drone conveyor belts are driven by means of an electric motor.

Preferably, the sliding bars can displace a drone in such a way that the drone is in contact with both drone conveyor belts simultaneously. Preferably, skids that are part of a landing frame of the drone can be moved by the sliding bars into a position parallel to the running direction of the drone conveyor belts.

Preferably, the sliding bars are driven by a chain drive. Preferably, the sliding bars are made of profiled high-grade steel. Preferably, when the sliding bars move away from each other, they can push foreign objects on the landing surface, such as, for example, twigs or leaves, outward and downward from the landing surface. Preferably, the two end positions of a sliding bar (“outer” and “inner”) are mechanically delimited. Preferably, the two end positions of the sliding bars (“outer” and “inner”) are interrogated by sensors. Preferably, when the drone moves into the is loading position, a landing frame of the drone aligned against a stop edge. Preferably, when the drone moves into the loading position, skids of a landing frame of the drone are moved under two hold-down straps. Preferably, attainment of the loading position is interrogated by sensors.

Preferably, hold-down straps hold a landing frame of the drone while the drone receives cargo arranged on the hoist.

Preferably, the hoist is in the form of a scissor lift table. Preferably, the height of the scissor lift table can be adjusted via a self-inhibiting spindle drive. Preferably, the end positions of the hoist are sensed by means of sensors. Preferably, the end positions of the hoist are secured against damage by means of safety stops. Preferably, driving of the hoist is effected by means of an electric motor and a flange-mounted transmission.

Preferably, the landing surface is at least 1.8 m by 1.8 m in size. This size makes it possible for the drone to land safely on the landing surface even if the drone is unable to land with greater precision due to external conditions or due to inaccuracies in the control system or locating system.

Preferably, the mobile device has a free space, laterally adjacent to the storage unit on the side opposite the landing platform, that can be used as a repair and servicing area.

Preferably, the mobile device is controlled by the drone.

The solutions according to the invention enable automation of drone flights with secure launching and landing, as well as exchange of drones and charging of drone batteries. The invention also enables automated loading and unloading of cargo for drones. The range of the drones is extended by the possibility of intermediate landing and battery charging the in device. This also increases the range of flights with cargo. A modular, self-sufficient system is provided that may be used anywhere in the world. The fact that the device can be inserted into a closed container means that drones stored in it can be protected against exposure to the weather and against unauthorized access.

The invention is explained in more detail with reference to the figures, which show an exemplary embodiment. In the figures:

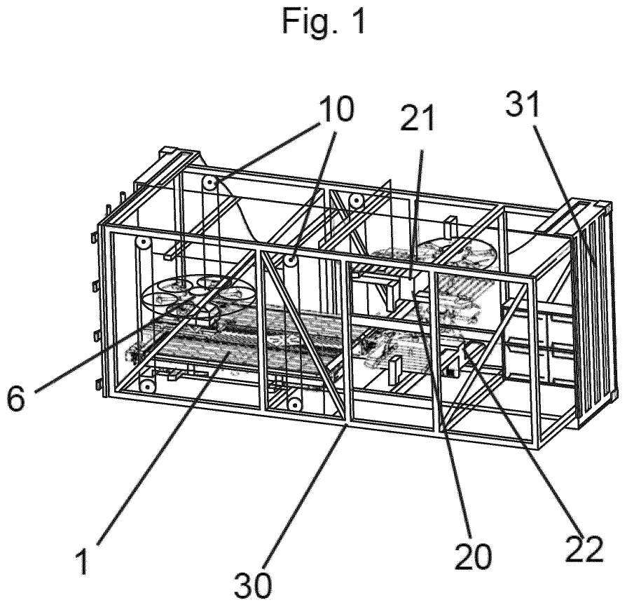

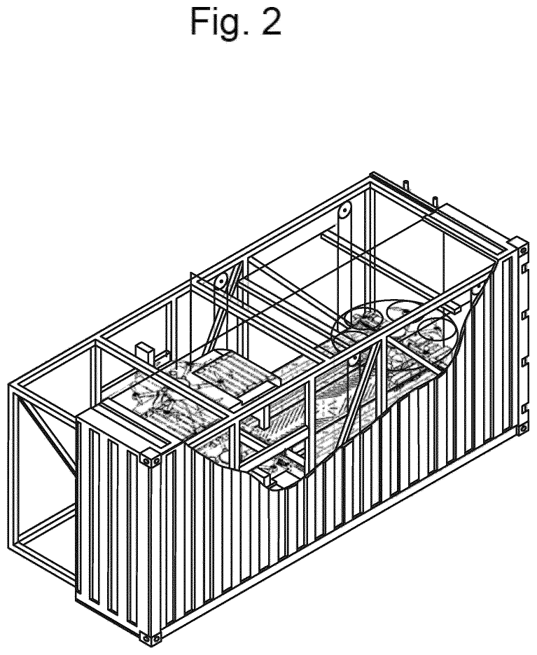

FIGS. 1 to 2: show a device according to the invention with one drone in the loading position and three drones in a storage position;

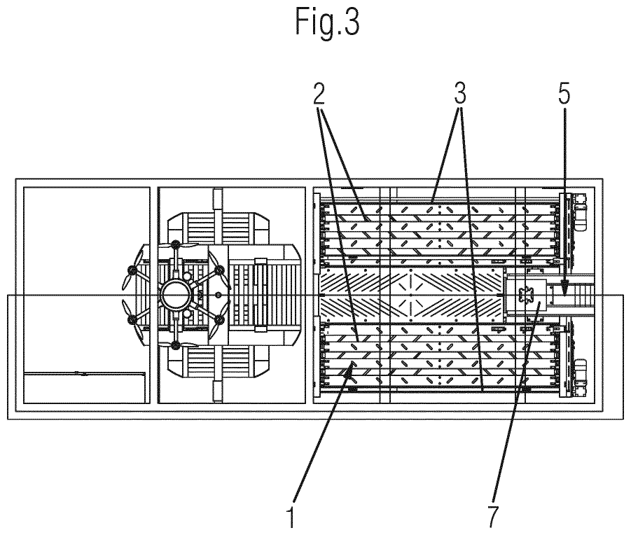

FIG. 3: shows a top view of a device according to the invention with a drone in a storage position;

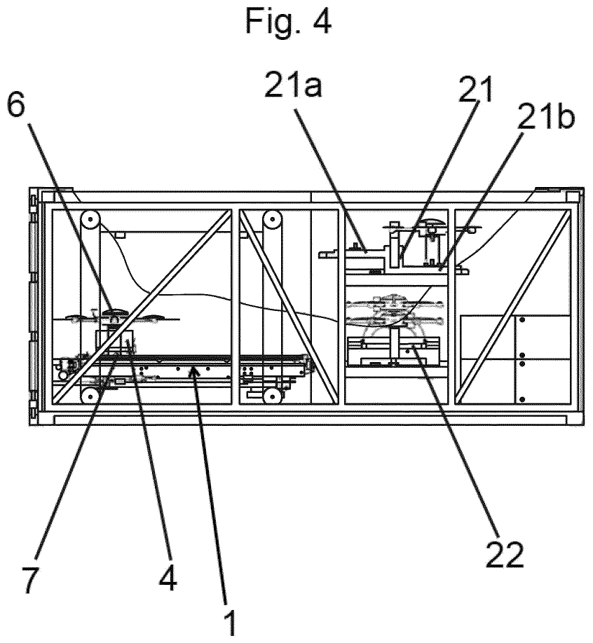

FIG. 4: shows a device according to the invention with one drone in the loading position and three drones in a storage position;

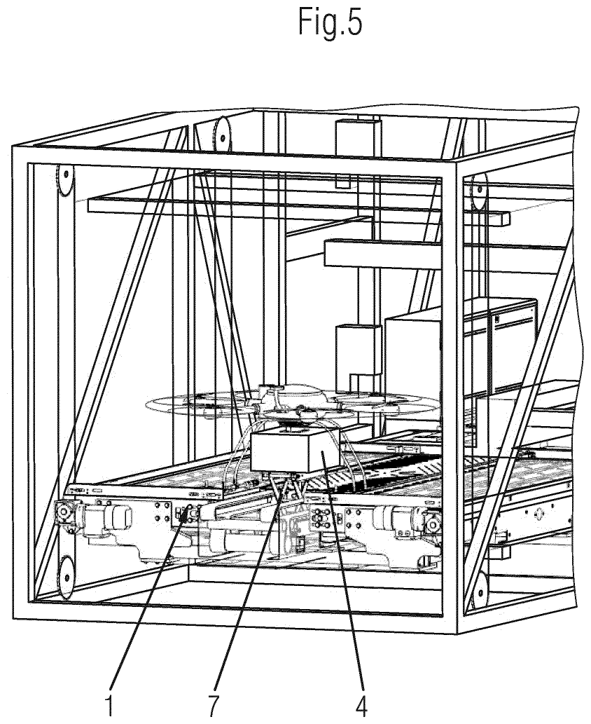

FIG. 5: shows a device according to the invention with a drone in the loading position;

FIG. 4: shows a device according to the invention with one drone in the loading position and three drones in a storage position;

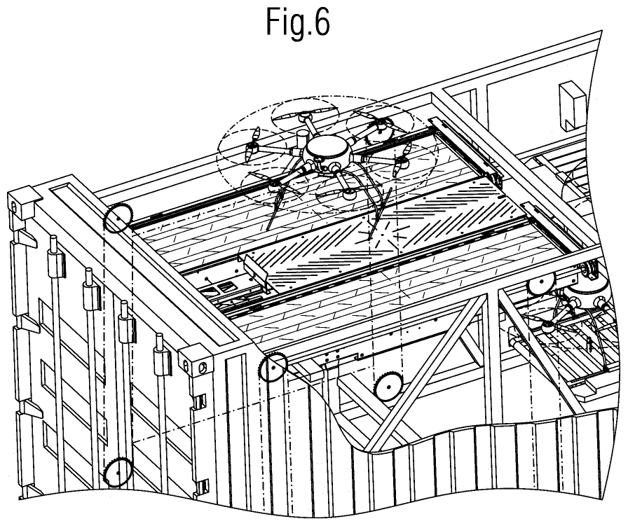

FIG. 6: shows a device invention with the according to the lifting unit at a launching height;

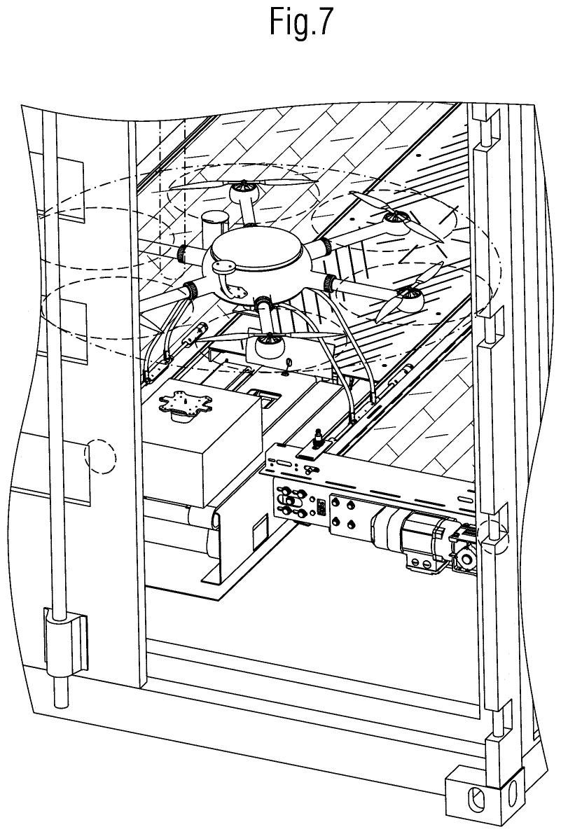

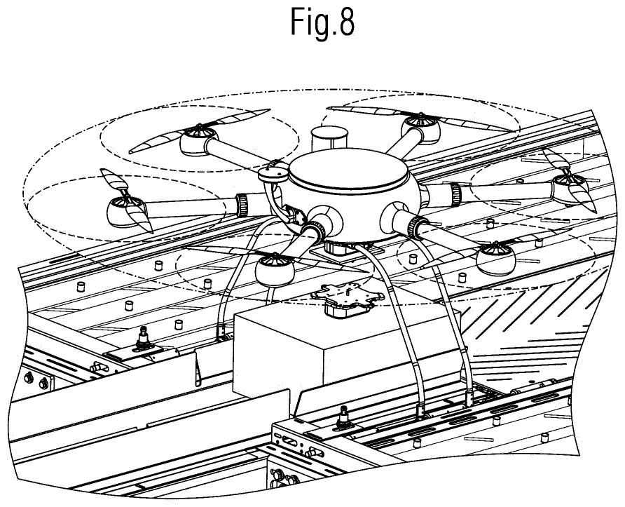

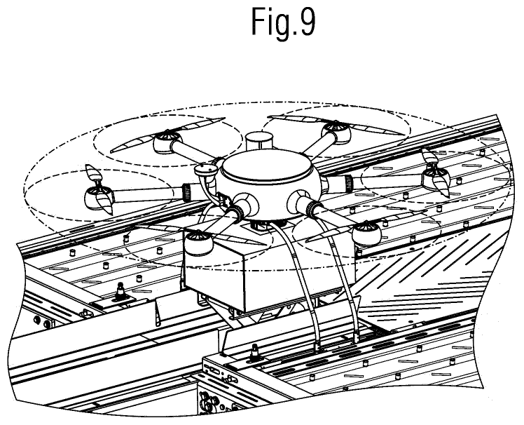

FIGS. 7 to 9: shows a device according to the invention with a drone in a loading position and the conveying, raising and gripping of a cargo;

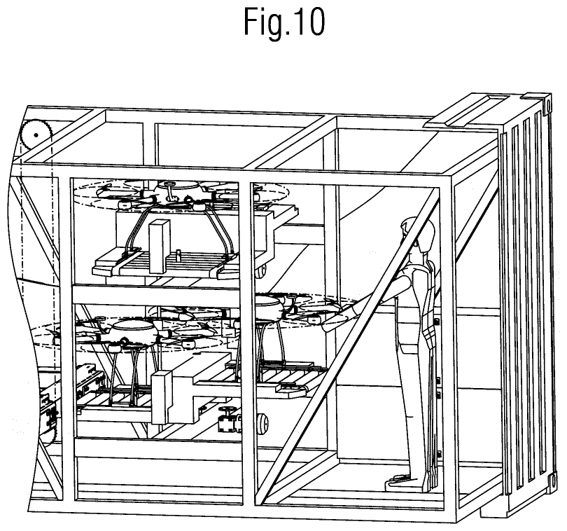

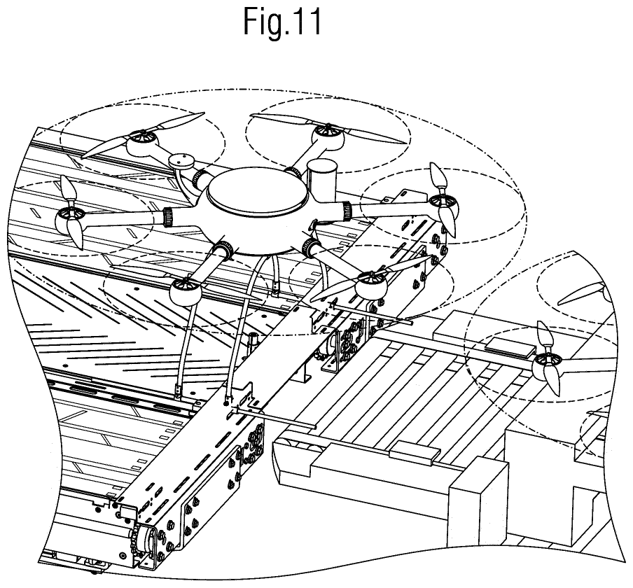

FIG. 10: shows a device according to the invention with a servicing area;

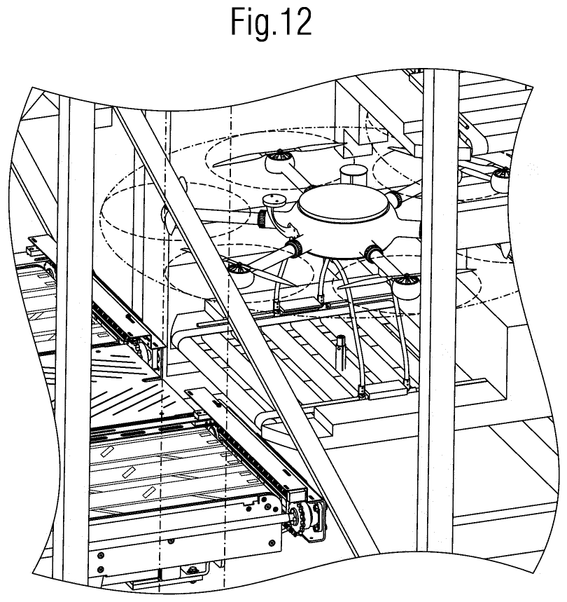

FIG. 11: shows the transfer of a drone from the landing platform to a storage level;

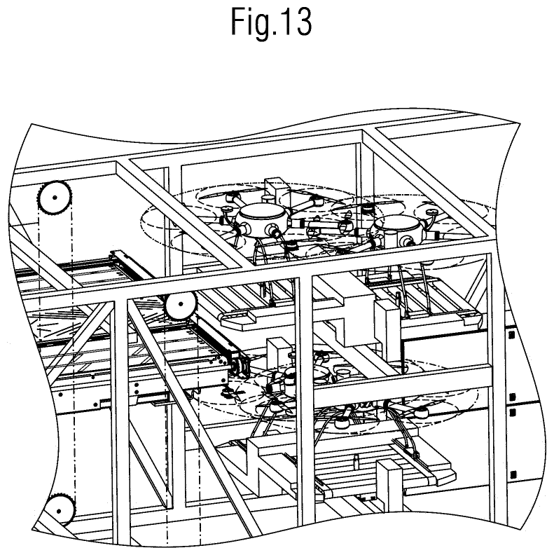

FIG. 13: shows a storage level with a drone in a storage position.

FIG. 1 shows a device according to the invention comprising a landing platform 1, a lifting unit 10 and a storage unit 20, which are fastened to a transport frame Partially is the casing, 30. indicated constituted by a standard sea freight container 31. The storage unit 20 comprises two rotary units 21 and 22, which are arranged one above the other and are rotatable about a vertical axis. Each rotary unit 21, 22 has two storage levels 21a, 21b and 22a, 22b respectively, which are arranged on opposite sides of the vertical axis, as shown in FIG. 4. The two storage levels 21a, 21b and 22a, 22b are arranged vertically offset from each other, such that, as viewed from above, the drone stored on one storage level can overlap the drone stored on the other storage level without the drones touching each other. As shown by FIG. 13, each storage level 21a, 21b, 22a, 22b comprises a conveying system that includes a conveying track 23 that enables a drone 6 to be received and/or transferred to the landing platform 1. The contact surface of the drone 6 in the storage position is constituted by the conveying track 23.

The lifting unit 10 enables the landing platform 1 to be raised and lowered to a height from which a drone 6 can launch and land (launching height), and to a height at which the landing platform 1 can transfer a drone to a storage level 21a, 21b, 22a, 22b or receive it from a storage level (storage-level height).

The mobile device is controlled by the drone 6.

The rotary unit 21 can be positioned in steps of 90 degrees. The position of the rotary unit 21 is sensed by means of sensors. The storage levels 21a, 21b, 22a, 22b have hold-down devices 24 for holding down the skids of the landing frame of the drone 6. The storage position of the drone 6 is sensed by means of sensors. The drone is pulled onto the storage level 21a, 21b, 22a, 22b by the conveying system and moved toward end stops.

The rotary unit 21 can also be rotated when a storage level 21a, 21b, 22a, 22b is at the same height as the landing platform 1. A battery of a drone 6 stored on the storage level can be charged in a position of the storage level 21a, 21b, 22a, 22b. Charging is effected via a charging lance. Following a 180 degree rotation from the transfer position of the storage level, the storage level 21a, 21b, 22a, 22b is accessible to a person.

The landing platform 1 comprises a landing surface comprising two drone conveyor belts 2 that are arranged in parallel in the same horizontal plane and that are spaced apart such that a drone 6 standing on the landing surface can have contact with both drone conveyor belts 2 simultaneously, two sliding bars 3, which each extend at least partially parallel to the running direction of the drone conveyor belts 2 and can be moved toward each other above the drone conveyor belts 2 in a direction perpendicular to the running direction of the drone conveyor belts 2, such that they can displace a drone 6 standing on the landing surface, wherein the drone 6 standing on the landing surface can be moved, by movement of the drone conveyor belts 2 and/or movement of the sliding bars 3, into a position in which the drone 6 can be transferred to a storage level 21a, 21b, 22a, 22b (drone transfer position).

A drone 6 can be moved, by movement of the drone conveyor belts 2 and/or movement of the sliding bars 3, into a horizontal position in which the drone 6 can launch (horizontal launching position of the drone).

The landing platform 1 comprises a cargo loading unit comprising a hoist 7 for cargo 4, arranged between the drone conveyor belts, a cargo conveyor belt for moving the cargo 4 onto the hoist 7, wherein the drone 6 standing on the landing surface can be moved, by movement of the drone conveyor belts 2 and/or movement of the sliding bars 3, into a position in which the drone 6 can pick up cargo 4 arranged on the hoist 7 (loading position).

The drone conveyor belts 2 are realized as modular conveyor belts. The individual elements of the modular conveyor belts are at least partially open, such that moisture can drain off.

The drone conveyor belts 2 are driven by means of an electric motor.

The sliding bars 3 can displace a drone 6 in such a way that the drone 6 is in contact with both drone conveyor belts 2 simultaneously. The skids of the landing frame of the drone 6 can be moved by the sliding bars 3 into a position parallel to the running direction of the drone conveyor belts 2. The sliding bars 3 are driven by a chain drive. The sliding bars 3 are made of profiled high-grade steel. When the sliding bars 3 move away from each other, they can push foreign objects on the landing surface, such as, for example, twigs or leaves, outward and downward from the landing surface. The two end positions of a sliding bar 3 (“outer” and “inner”) are mechanically delimited. The two end positions of the sliding bars 3 (“outer” and “inner”) are interrogated by sensors. When the drone 6 moves into the loading position, a landing frame of the drone 6 is aligned against a stop edge. When the drone 6 moves into the loading position, the skids of the landing frame of the drone 6 are moved under two hold-down straps. Attainment of the loading position is interrogated by sensors.

Hold-down straps hold a landing frame of the drone 6 while the drone picks up cargo 4 arranged on the hoist 7.

The hoist 7 is in the form of a scissor lift table. The end positions of the hoist 7 are sensed by means of sensors.

The end positions of the hoist 7 are secured against damage by means of safety stops. Driving of the hoist 7 is effected by means of an electric motor and a flange-mounted transmission.

The landing surface is approximately 1.8 m by 1.8 m in size. This size makes it possible for the drone 6 to land safely on the landing surface even if the drone is unable to land with greater precision due to external conditions or due to inaccuracies in the control system or locating system.

As shown by FIG. 10, the mobile device has a free space, laterally adjacent to the storage unit 20 on the side opposite the landing platform 1, that can be used as a repair and servicing area.

1.-33. (Canceled)

34. A mobile device for dispatching and receiving drones, comprising
a landing platform,
a lifting unit for adjusting the height of the landing platform, and
a storage unit,
wherein the lifting unit enables the landing platform to be raised and lowered to a height from which a drone can launch and land (launching height), and to a height at which the landing platform can transfer a drone to a storage level of the storage unit or receive it from a storage level (storage-levels height).

35. The device as claimed in claim 34, wherein the landing platform, the lifting unit and the storage unit are fastened in a transport frame.

36. The device as claimed in claim 35, wherein the transport frame can be inserted as a complete module into a standard sea freight container.

37. The device as claimed in claim 36, wherein the sea freight container has a roof that is designed to open and close.

38. The device as claimed in claim 34, wherein the storage unit comprises a rotary unit that can rotate about a vertical axis and that has two storage levels arranged on opposite sides of the vertical axis.

39. The device as claimed in claim 38, wherein the two storage levels are arranged vertically offset from each other, such that, as viewed from above, the drone stored on one storage level can overlap the drone stored on the other storage level without the drones touching each other.

40. The device as claimed in claim 38, wherein the storage unit comprises two rotary units arranged one above the other.

41. The device as claimed in claim 38, wherein each storage level comprises a conveying system, comprising a conveying track or a roller track, that enables a drone to be received and/or transferred to the landing platform.

42. The device as claimed in claim 41, wherein a contact surface of the drone in the storage position is constituted by the conveying or roller track.

43. The device as claimed in claim 38, wherein the rotary unit can be positioned in steps of 90 degrees.

44. The device as claimed in claim 38, wherein the position of the rotary unit is sensed by means of sensors.

45. The device as claimed in claim 34, wherein the storage levels have hold-down devices for holding down skids of a landing frame of a drone.

46. The device as claimed in claim 34, wherein the storage position of the drone is sensed by means of sensors.

47. The device as claimed in 41, wherein the conveying system has drivers for transferring the drone to the parking level.

48. The device as claimed in claim 41, wherein the drone is pulled onto the storage level by the conveying system and moved toward end stops.

49. The device as claimed in claim 34, wherein a locking mechanism can fix the drone in place on the storage level.

50. The device as claimed in claim 38, wherein the rotary unit can also be rotated when a storage level is at the same height as the landing platform.

51. The device as claimed in claim 38, wherein a battery of a drone stored on the storage level can be charged in a position of the storage level.

52. The device as claimed in claim 51, wherein charging is effected by means of a charging lance.

53. The device as claimed in claim 34, wherein, following a 180 degree rotation from the transfer position of the storage level, the storage level is accessible to a person.

54. The device as claimed in claim 34, wherein the landing platform comprises:
a landing surface, comprising
two conveyor belts that are arranged in parallel in the same horizontal plane and that are spaced apart such that a drone standing on the landing surface can have contact with both conveyor belts simultaneously (drone conveyor belts), and
two sliding bars, which each extend at least partially parallel to the running direction of the drone conveyor belts and can be moved toward each other above the drone conveyor belts in a direction perpendicular to the running direction of the drone conveyor belts, such that they can displace a drone standing on the landing surface,
wherein the drone standing on the landing surface can be moved, by movement of the drone conveyor belts and/or movement of the sliding bars, into a position in which the drone can be transferred to a storage level (drone transfer position).

55. The device as claimed in claim 54, wherein a drone can be moved, by movement of the drone conveyor belts and/or movement of the sliding bars, into a horizontal position in which the drone can launch (horizontal launching position of the drone).

56. The device as claimed in claim 54, wherein the landing platform comprises:
a cargo loading unit, comprising
a hoist for cargo, arranged between the drone conveyor belts, a cargo conveyor belt, arranged at least partially between the drone conveyor belts, for moving the cargo onto the hoist,
wherein the drone standing on the landing surface can be moved, by movement of the drone conveyor belts and/or movement of the sliding bars, into a position in which the drone can receive cargo arranged on the hoist (loading position).

57. The device as claimed in claim 54, wherein the drone conveyor belts are realized as modular conveyor belts.

58. The device as claimed in claim 54, wherein the sliding bars can displace a drone in such a way that the drone is in contact with both drone conveyor belts simultaneously.

59. The device as claimed in claim 54, wherein skids that are part of a landing frame of the drone can be moved by the sliding bars into a position parallel to the running direction of the drone conveyor belts.

60. The device as claimed in claim 54, wherein the two end positions of a sliding bar (“outer” and “inner”) are mechanically delimited.

61. The device as claimed in claim 56, wherein attainment of the loading position is interrogated by sensors.

62. The device as claimed in claim 56, wherein hold-down straps hold a landing frame of the drone while the drone receives cargo arranged on the hoist.

63. The device as claimed in claim 56, wherein the end positions of the hoist are sensed by means of sensors.

64. The device as claimed in claim 34, wherein the landing surface is at least 1.8 m by 1.8 m in size.

65. The device as claimed in claim 34, wherein the mobile device has a free space, laterally adjacent to the storage unit on the side opposite the landing platform, that can be used as a repair and servicing area.

66. The device as claimed in claim 34, wherein the mobile device is controlled by the drone.
